(19) United States
(12) Patent Application Publication
(10) Pub. No.: US 2010/0089010 A1
(43) Pub. Date: Apr. 15, 2010

(54) Method and device for plastic wrap

(76) Inventors: Guy Dodelson, Kfar Saba (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/645,897

(22) Filed: Dec. 28, 2006

(51) Int. Cl. B65B 67/08; B65B 11/00; B65B 41/12; B26F 3/02; B26F 3/08; B65B 61/04; B65B 61/10; B26D 7/10

(52) U.S. Cl. 53/461; 53/203; 83/16; 225/4; 225/39

(57) ABSTRACT

A plastic or nylon wrap gripper to pull the wrap off its roll in such a way that the lose ends of wrap material will not fold back on itself and stick to itself. Hand held gripping device made to grip the plastic wrap by a hand and wrist movement and thereby pull the wrap off its roll.

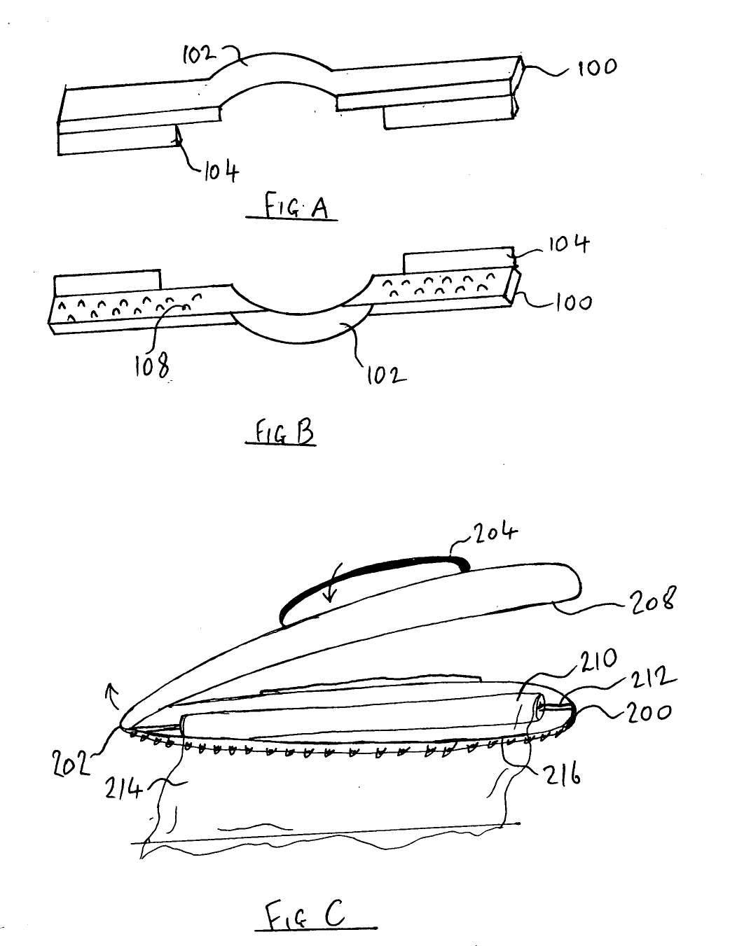

### FIELD of the INVENTION

This invention is in the field of dispensers and in particular the dispensers of thin plastic film wrap material.

### BACKGROUND OF THE INVENTION

The use of plastic film wrap is well known in the art, especially in the food industry. It is a cheap method of preserving the freshness of food products by covering them or sealing them. Thin plastic film wrap (hereinafter known as “plastic-wrap”) is used with a wide range of products and the present invention also could assist with wrapping them but for the sake of clarity, reference in this patent application will refer to the use of plastic-wrap in the domestic food industry.

One of the main difficulties with handling plastic-wrap is that it is not convenient to use. Non-domestic industry often has machinery to stretch and wrap the plastic-wrap around the object being wrapped. This is not so in the domestic industry. The consumer buys a box of plastic-wrap that sometimes has a serrated edge on the box to assist cutting the plastic-wrap. The actual wrapping process is awkward to perform because one hand is usually holding the box of plastic-wrap and the other hand has to hold the item being wrapped and do the wrapping. By its nature the plastic-wrap sticks to itself. This is one of the intended and positive features of plastic-wrap but it can also cause a problem when drawing the plastic-wrap from its reel. Often the loose end will cling onto another piece of itself and is either separated with frustration and difficulty or that piece is cut off and a new attempt is made. Either way there is wasted time and/or material.

There is a need for a simple device that would be within the financial ability of most households to assist with this everyday action of pulling plastic-wrap off its roll, wrapping it around the object to be wrapped, wrapping it tight so that it clings and seals itself and cutting off the connection to the dispensing roll of plastic-wrap.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

The object of this invention is to assist the end user of plastic-wrap to conveniently pull off a certain amount of plastic-wrap from the source roll, wrap it around the object to be wrapped and cut off the plastic-wrap from the roll while preventing the plastic-wrap from folding back onto itself and sticking to itself.

Another object of this invention is to have the roll of plastic-wrap as an integral part of the device.

Another object of this invention is to have a device that can pull, wrap and cut the plastic-wrap from a roll of plastic-wrap.

Another object of this invention is to have a device that is non-mechanical, hand-held, non-costly that works with a simple movement of the hand and wrist.

### BRIEF DESCRIPTION of the DRAWINGS

The accompanying drawings, which are incorporated in and form a part of this specification, illustrate embodiments of the invention and, together with the description, serve to explain, by way of example only, the principles of the invention:

Fig A is a schematic depiction of a device of this invention to pull on plastic-wrap and cut it.

Fig B is a schematic depiction of a device of this invention showing the underside.

Fig C is a schematic depiction of this invention with the roll of plastic-wrap as an integral part of the device with a sharp edge for quick cutting of the plastic-wrap at the desired length while avoiding disturbing the part of the wrap that has been wrapped around the item.

### DESCRIPTION of the PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

Fig A shows a plastic-wrap gripping device 100 with an integral handle 102 to hold the said device in one hand. The raised piece 102 is sufficiently high to keep the hand away from the sheet of plastic-wrap even when the hand is twisting down to the direction of the plastic-wrap as is explained herein. The plastic-wrap is gripped by non-sharp protrusions Fig B 108 situated on the underside of the said device. The protrusions Fig B 108 could be made of any suitable material that could grip the plastic-wrap like for example rubber, silicon or plastic. The plastic-wrap is then pulled by the person holding the device pulling the gripped plastic-wrap off the roll of plastic-wrap. The non-sharp edges 104 help to pull the plastic-wrap without tearing and help to distance the hand from the plastic-wrap.

The manual action required to operate the device of this invention is a wrist pivoted movement of the hand. The action of the user's hand starts with gripping the plastic-wrap by pressing the non-sharp protrusions Fig B 108 onto the plastic-wrap. This is done by bending the gripping hand backward so that the back of the hand is closest to the forearm and then the protrusions Fig B 108 are pressed onto a pulled-out end piece from the roll of plastic-wrap.

The movement of the hand that is holding the gripping device, is a circular motion pivoted around the wrist where such circular motion is in a plane perpendicular to the plane of the plastic wrap.

Once gripped, the plastic-wrap is pulled, to pull off the roll of plastic-wrap as much as is required for the wrapping process. This pulling motion is achieved by straightening out the hand so that the non-sharp edges 104 pull the plastic-wrap without tearing the plastic-wrap. The item to be wrapped is then surrounded with plastic-wrap. The wrap is severed from the roll by pulling the taught wrap over a sharp or serrated edge of the box holding the roll. In the absence of such a sharp edge, a knife could be used.

Fig B shows the same device 100 as Fig A from the underside view. The handle 102 and blunt edges 104 are also shown. The protrusions 108 are used to grip the plastic-wrap by being pressed down on the plastic wrap which can then be pulled uniformly off the roll without the wrap tearing or folding back and attach itself to other parts of the plastic-wrap as it is pulled off the roll.

Fig C is a device 200 with a roll of plastic-wrap 210 situated inside the device 200. The handle 204 is used to hold the device 200 and also to open the lid 208 that is attached to the base by hinge 202. The roll 210 revolves around the axle 212. When the lid 208 is closed there is a gap through which the plastic-wrap 214 can be pulled. The free end of the wrap 214 is placed over the article to be wrapped and the device 200 is pulled until sufficient wrap 214 has come off the roll 210. Then the device is turned on its longitudinal axis by a forward turning of the user's hand with the wrist as the pivot, until the sharp edge 216 presses against the plastic-wrap 214 to sever the wrap 214 from the roll of plastic-wrap 210. This method of quick and smooth cutting of the plastic-wrap has the effect of not disturbing the carefully placed wrap that has been put around the item to be wrapped. Without this sharp edge 216 feature the neatly wrapped plastic-wrap is often dislodged from its position by the pressure required to cut the wrap from the roll.

What is claimed is:

1. A hand held plastic-wrap pulling device for pulling plastic-wrap off its roll comprising,
a handle attached to a frame of the said plastic-wrap pulling device,
at least two non-sharp protrusions attached to the underside of the said hand held plastic-wrap pulling device to grip the plastic-wrap without tearing the same,
at least one non-sharp edge on the underside of the said hand held plastic-wrap pulling device to aid the pulling of the said plastic-wrap off its roll without tearing the same,
whereby the plastic-wrap can be pulled off its roll, wrapped around an object using the wrist pivoted movement of the user's hand to operate the said hand held plastic-wrap pulling device and whereby the said plastic-wrap is held taught to avoid loose portions of the said wrap from folding back and touching the said wrap.

2. A hand held plastic-wrap pulling device as claimed in claim 1 wherein the said handle is an integral part of the said frame of the said hand held plastic-wrap pulling device.

3. A hand held plastic-wrap pulling device as claimed in claim 1 wherein the said protrusions are made of rubber.

4. A hand held plastic-wrap pulling device as claimed in claim 1 wherein the said protrusions are made of plastic.

5. A hand held plastic-wrap pulling device as claimed in claim 1 wherein the said protrusions are made of silicon.

6. A hand held plastic-wrap pulling device for pulling plastic-wrap off its roll comprising
a rod passing through the hollow axis of a roll of plastic-wrap,
a casing to house the said roll of plastic-wrap,
a sharp cutting edge on the said casing to cut the said plastic-wrap from its roll by a twisting action of the hand,
whereby the said plastic-wrap is held taught to avoid it touching itself.

7. A hand held plastic-wrap pulling device as claimed in claim 6 wherein the said means to grip the plastic-wrap is made of rubber.

8. A hand held plastic-wrap pulling device as claimed in claim 6 wherein the said means to grip the plastic-wrap is made of plastic.

9. A hand held plastic-wrap pulling device as claimed in claim 6 wherein the said means to grip the plastic-wrap is made of silicon.

10. A hand-held plastic-wrap pulling device for gripping plastic-wrap and pulling the said wrap off a roll of plastic-wrap comprising the following steps namely,
a. pulling the end piece of the said plastic-wrap off the said roll to expose a portion of the said plastic-wrap,
b. holding the said hand-held plastic gripping device in one hand,
c. bending the said hand backward using the wrist as a pivot,
d. pressing protrusions from the said gripping device onto the said exposed portion of the said plastic-wrap,
e. straightening the said hand so that the said protrusions grip the said plastic-wrap,
f. pulling backward the said hand and the arm of the said hand thereby pulling plastic-wrap off a roll of plastic-wrap while preventing the said plastic wrap folding back onto itself.
